(19) United States
(12) Patent Application Publication
(10) Pub. No.: US 2021/0395415 A1
(43) Pub. Date: Dec. 23, 2021

(54) HIGH DELAMINATION STRENGTH CARPET BINDER

(71) Applicant: BASF SE, Ludwigshafen am Rhein (DE)

(72) Inventors: Kostas S. AVRAMIDIS, Charlotte, NC (US); Barry R. FOWLER, Chattanooga, TN (US); John BENNETT, Chattanooga, TN (US); Bert A. TEMPLETON, Chattanooga, TN (US)

(21) Appl. No.: 17/292,534

(22) PCT Filed: Nov. 8, 2019
(86) PCT No.: PCT/US2019/060540

§ 371 Date: May 10, 2021

Related U.S. Application Data
(60) Provisional application No. 62/758,177, filed on Nov. 9, 2018.

(51) Int. Cl. C08F 212/08; D06N 3/10; D06N 7/00

(52) U.S. Cl. CPC C08F 212/08; D06N 7/0073; D06N 3/10

(57) ABSTRACT

Carpet binder compositions comprising a mineral filler and a copolymer produced by emulsion polymerization and derived from monomers comprising a vinyl aromatic monomer, a 1,3-diene monomer, and an additional monomer selected from a copolymerizable surfactant, a (meth)acrylate monomer, a carboxylic acid monomer, or a combination thereof are disclosed. The carpet binder compositions can be formulated with a non-polymerizable surfactant such as an aryl phosphate surfactant. The compositions exhibit superior wet and dry delamination strengths as well as suitable froth viscosities. As a result, such carpet binder compositions can be made at higher filler loadings.

### FIELD OF THE DISCLOSURE

The present disclosure relates to carpet binder compositions, particularly to compositions having improved delamination strength.

### BACKGROUND

Most conventional carpets include a primary backing with yarn tufts that extend upwards from the backing and form a pile surface. For tufted carpets, the yarn is inserted into the primary backing using tufting needles and a primary binder (pre-coat) is applied to secure the yarn tufts. The pre-coat secures the carpet tufts to the primary backing. For non-tufted carpets, the fibers are embedded and held in place by the pre-coat. Carpet construction may also include a secondary backing laminated or bonded to the primary backing by an adhesive formulation. The adhesive formulation can include the same binder as the pre-coat. The secondary backing provides dimensional stability, absorbs noise, and provides extra padding to the carpet. Similar techniques are practiced in the construction of broadloom carpets and carpet tiles. A consideration for carpet quality is durability which is reflected in the resistance to separate the primary backing from the secondary backing under dry or wet conditions, also referred to herein as delamination strength.

The properties of the binder used for the precoat and the adhesive formulation are important for the construction of the carpet. The binder provides adhesion of the precoat to the pile fibers and bonding of the secondary backing to the primary backing. In addition, the binder is desirably soft and flexible, even at high filler loading and/or low temperature to facilitate easy rolling and unrolling during installation. During application of the binder to the carpet backing, the binder is generally frothed to create air bubbles in the binder which aids in controlling the binder's coat weight and ultimately the carpet's manufacturing cost. Desirable binders include those in which the frothed compound density is achieved quickly and reproducibly.

There is a need for carpet binders that exhibit superior froth viscosities and provide high dry and wet delamination strengths. The compositions and methods described herein address these and other needs.

### SUMMARY OF THE DISCLOSURE

Carpet binder compositions are disclosed herein. The carpet binder compositions can include a mineral filler and a copolymer produced by emulsion polymerization and derived from monomers comprising a vinyl aromatic monomer, a 1,3-diene monomer, and an additional monomer selected from a copolymerizable surfactant, a (meth)acrylate monomer, a carboxylic acid monomer, or a combination thereof. In some embodiments, the additional monomer includes a copolymerizable surfactant. In other embodiments, the additional monomer includes a (meth)acrylate monomer. In further embodiments, the additional monomer includes a carboxylic acid monomer. In some examples, the copolymer can be produced by emulsion polymerization and consists essentially of a vinyl aromatic monomer, a 1,3-diene monomer, and a copolymerizable surfactant.

As described herein, the copolymer can be derived from an additional monomer selected from a copolymerizable surfactant, a (meth)acrylate monomer, a carboxylic acid monomer, or a combination thereof. When the additional monomer includes a (meth)acrylate monomer, the (meth)acrylate monomer can be selected from methyl (meth)acrylate, ethyl (meth)acrylate, t-butyl (meth)acrylate, cyclohexyl (meth)acrylate, acrylonitrile, or combinations thereof, and preferably includes methyl methacrylate. In some embodiments, the (meth)acrylate monomer can include methyl methacrylate. When present, the (meth)acrylate monomer can be in an amount of from 0.5% to 30% by weight, from 0.5% to 15% by weight, or from 0.5% to 10% by weight, based on the weight of the copolymer.

When the additional monomer includes a carboxylic acid monomer, the carboxylic acid monomer can be selected from acrylic acid, methacrylic acid, itaconic acid, maleic acid, fumaric acid, crotonic acid, or a mixture thereof. In some embodiments, the carboxylic acid monomer can include acrylic acid. When present, the carboxylic acid monomer can be in an amount of from 0.5% to 4% by weight, preferably from 0.5% to 3% by weight, or from 1.5% to 3% by weight, based on the weight of the copolymer.

When the additional monomer includes a copolymerizable surfactant, the copolymerizable surfactant can be selected from an acrylic acid-modified polyoxyethylene alkyl ether, an acrylic acid-modified polyoxyethylene alkyl phenyl ether, an allylic acid-modified polyoxyethylene alkyl ether, an allylic acid-modified polyoxyethylene alkyl phenyl ether, an allylic acid-modified polyoxyethylene polystyrylphenyl ether, an acrylic acid-modified polyoxyethylene polystyrylphenyl ether, polyoxyethylene-polyoxypropylene glycol monoacrylate, and mixtures thereof.

In certain embodiments, the copolymerizable surfactant can be of formula I, or a salt thereof:

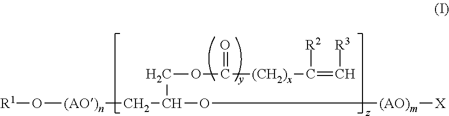

wherein R¹ represents a branched aliphatic hydrocarbon group, a secondary aliphatic hydrocarbon group or a branched aliphatic acyl group, AO and AO′ each independently represents an oxyalkylene group having 2 to 4 carbon atoms, R² and R³ each independently represents a hydrogen atom or a methyl group, X represents a hydrogen atom or an ionic hydrophilic group, x is an integer from 0 to 12, y is 0 or 1, z is an integer from 1 to 10, m is an integer from 0 to 1,000, and n is an integer from 0 to 1,000. In some examples, the copolymerizable surfactant can be of formula Ia:

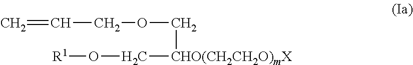

wherein R¹ is C₉-C₁₅ alkyl or C₇-C₁₁ alkyl-phenyl, X is H, SO₃NH₄ or SO₃Na, and m is from 3 to 50. In some instances, R¹ can be C₁₀-C₁₄ alkyl and m is from 5 to 25. When present, the copolymerizable surfactant can be present in an amount from greater than 0% to 5% by weight, from 0.1% to 5% by weight, or from 0.1% to 1.5% by weight, based on the weight of the copolymer.

Additional surfactants can be present in the carpet binder compositions. The additional surfactant can be selected from an aryl phosphate surfactant. When present, the aryl phosphate surfactant can include an alkoxylated polyarylphenol phosphate ester of the formula (II):

CₓH_{y}—O-(AO)ₙ—PO₄²⁻

wherein AO represents an oxyalkylene group having 2 to 4 carbon atoms; CₓH_{y} represents one or more substituted or unsubstituted aryl groups wherein x is an integer 20 or greater, preferably 30 or greater, more preferably from 30 to 40, and y is an integer 14 or greater, preferably from 14 to 34, and more preferably from 24 to 34; and n is an integer 1 or greater, preferably 10 or greater, more preferably from 10 to 150. In some examples, the aryl phosphate surfactant can include an alkoxylated polyarylphenol phosphate ester of the formula (IIa):

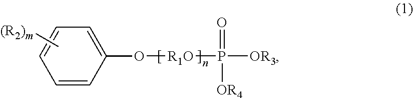

wherein R₁ independently is a straight chain or branched C₂-C₄ alkylene, R₂ is aryl or alkylaryl, wherein R₂ is unsubstituted or substituted by one to three groups selected from the group consisting of C₁-C₄ alkyl or C₁-C₄ alkoxy, and R₃ and R₄ are independently selected from the group consisting of hydrogen, sodium, potassium, ammonium, and

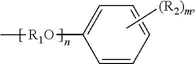

m is 2 or 3, and n is a number from 1 to 150 inclusive. In further examples, the aryl phosphate surfactant can have the formula (IIa-1):

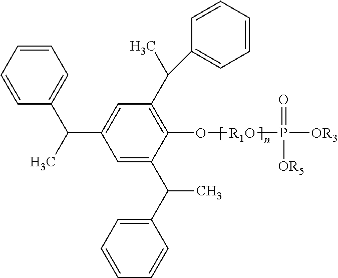

wherein R₁ and n are defined as above, preferably R₁ is ethylene, and R₃ and R₅ are independently selected from the group consisting of hydrogen, sodium, potassium, and ammonium. In some instances, n can be from 4 to 25, preferably n is from 14 to 18. When present, the carpet binder composition can include from greater than 0% to 5% by weight, from 0.1% to 5% by weight, or from 0.1% to 1.5% by weight, of the aryl phosphate surfactant.

The additional surfactant can be present whether or not the copolymer includes a copolymerizable surfactant. For example, the carpet binder composition can include a copolymer derived from monomers comprising a vinyl aromatic monomer, a 1,3-diene monomer, and an additional monomer selected from a copolymerizable surfactant, a (meth)acrylate monomer, a carboxylic acid monomer, or a combination thereof and an aryl phosphate surfactant. In some embodiments, the aryl phosphate surfactant can be present when the copolymer does not include a copolymerizable surfactant. For example, the carpet binder composition can include a copolymer derived from monomers comprising a vinyl aromatic monomer, a 1,3-diene monomer, and an additional monomer selected from a (meth)acrylate monomer, a carboxylic acid monomer, or a combination thereof and an aryl phosphate surfactant.

As described herein, the copolymer can be derived from a vinyl aromatic monomer and a 1,3-diene monomer further to the additional monomers. The vinyl aromatic monomer can be present in an amount of from 5%-80% by weight, from 40%-80% by weight, from 30%-80% by weight, or from 50%-80% by weight, based on the weight of the copolymer. In some examples, the vinyl aromatic monomer comprises styrene. The 1,3-diene monomer can be present in an amount from 5%-80% by weight, from 15%-70% by weight, from 15% to 55% by weight, or from 20%-50% by weight, based on the weight of the copolymer. In some examples, the 1,3-diene monomer comprises butadiene. The copolymer can include one or more further monomers. The one or more further monomers can be selected from a (meth)acrylonitrile monomer, a (meth)acrylamide monomer, an organosilane, a crosslinking monomer, a glycidyl (meth)acylate, or a combination thereof.

In some examples, the copolymer can be derived from 40% to 80% by weight styrene, 15% to 55% by weight of butadiene, an additional monomer selected from a copolymerizable surfactant, methyl methacrylate, acrylic acid, or a combination thereof, and 0% to 4% by weight of one or more further monomers selected from an additional (meth)acrylate monomer, a (meth)acrylonitrile monomer, a (meth)acrylamide monomer, an organosilane, a crosslinking monomer, a glycidyl (meth)acylate, or a combination thereof.

In other examples, the copolymer can be derived from 40% to 80% by weight styrene; 20% to 55% by weight of butadiene; 1.5% to 5% by weight of a carboxylic acid monomer selected from acrylic acid, itaconic acid, or a combination thereof; 5% to 30% by weight of methyl methacrylate; and 0% to 4% by weight of one or more further monomers selected from an additional (meth)acrylate monomer, a (meth)acrylonitrile monomer, a (meth)acrylamide monomer, an organosilane, a crosslinking monomer, glycidyl (meth)acylate, or a combination thereof.

In other examples, the copolymer can be derived from 40% to 80% by weight styrene; 20% to 55% by weight of butadiene; 1.5% to 5% by weight of a carboxylic acid monomer selected from acrylic acid, itaconic acid, or a combination thereof; 0.1% to 2% by weight of a copolymerizable surfactant; and 0% to 4% by weight of one or more further monomers selected from an additional (meth)acrylate monomer, a (meth)acrylonitrile monomer, a (meth)acrylamide monomer, an organosilane, a crosslinking monomer, glycidyl (meth)acylate, or a combination thereof.

In other examples, the copolymer can be essentially derived from styrene, butadiene, a copolymerizable surfactant, and optionally a carboxylic acid monomer. For example, the copolymer can be essentially derived from 40% to 80% by weight styrene, from 15% to 55% by weight of butadiene, 0.1% to 10% by weight of the copolymerizable surfactant, and optionally a carboxylic acid monomer.

The copolymer can have a theoretical glass-transition temperature of 80° C. or less, preferably from −40° C. to 80° C., more preferably from −20° C. to 60° C., or most preferably from 0° C. to 40° C. The copolymer can have a number average particle size of 50 nm or greater, preferably from 50 nm to 300 nm, more preferably from 80 nm to 200 nm. The copolymer can be present in an amount of 10% by weight or greater, preferably from 15% to 30% by weight, based on the total weight of the carpet binder composition.

The carpet binder compositions can include a mineral filler. Suitable mineral fillers can be selected from calcium carbonate, titanium dioxide, kaolin, bentonite, mica, talc, attapulgite, zeolite, aluminum trihydrate, fly ash, or mixtures thereof. The mineral filler can have a number average particle size of 10 microns or greater, preferably from 10 microns to 100 microns, more preferably from 10 microns to 50 microns. The mineral filler can be present in an amount of 10% by weight or greater, preferably from 10% to 85% by weight, more preferably from 30% to 85% by weight, based on the total weight of the carpet binder composition. The mineral filler and the copolymer can be in a weight ratio of from 1:1 to 20:1, based on the weight of solids in the copolymer and mineral filler.

The carpet binder compositions can further comprise a thickener, a surfactant, a dispersant, or a combination thereof.

The carpet binder compositions described herein can exhibit improved delamination strength compared to other carpet binder compositions. For example, the carpet binder composition can exhibit a one minute wet delamination strength for a straight stitch nylon loop carpet, as determined using ASTM D3936, of 7 psi or greater, for a 7.62 cm wide strip. In certain embodiments, the one minute wet delamination strength for a straight stitch nylon loop carpet, as determined using ASTM D3936, can be at least 8 psi, preferably at least 10 psi, for a 7.62 cm wide strip. The carpet binder compositions can have a dry delamination strength for a straight stitch nylon loop carpet, as determined using ASTM D3936, of 12.5 psi or greater, preferably at least 14 psi, more preferably at least 16 psi, for a 7.62 cm wide strip. The froth (foam) viscosity of the carpet binder composition can be 28,000 cp to 35,000 cp, preferably from 30,000 cp to 35,000 cp, as determined using a Brookfield viscometer at 21° C., spindle #6 at 20 rpm.

In some examples, the carpet binder composition comprises a copolymer produced by emulsion polymerization and derived from monomers comprising a vinyl aromatic monomer, a 1,3-diene monomer, and an additional monomer selected from a copolymerizable surfactant, a (meth)acrylate monomer, a carboxylic acid monomer, or a combination thereof, and a mineral filler; wherein the composition has a one minute wet delamination strength for a 7.62 cm wide straight stitch nylon loop carpet, as determined using ASTM D3936, of 7 psi or greater. In other examples, the carpet binder composition comprises a copolymer produced by emulsion polymerization and derived from monomers comprising a vinyl aromatic monomer, a 1,3-diene monomer, and an additional monomer selected from a copolymerizable surfactant, a (meth)acrylate monomer, a carboxylic acid monomer, or a combination thereof, and a mineral filler having a number average particle size of 10 microns or greater, preferably from 10 microns to 100 microns, more preferably from 10 microns to 50 microns.

Carpets comprising the carpet binder compositions disclosed herein are also described. The carpets can include the carpet binder composition having a coating weight of from 1,500 g/m² or less, preferably from 800 g/m² to 1,200 g/m².

Methods of making and using the carpet binder compositions are also described. The method of making the compositions can include mixing a mineral filler and a copolymer produced by emulsion polymerization and derived from monomers comprising a vinyl aromatic monomer, a 1,3-diene monomer, and an additional monomer selected from a copolymerizable surfactant, a (meth)acrylate monomer, a carboxylic acid monomer, or a combination thereof to form a mixture. The mixture can develop a one minute wet delamination strength for a straight stitch nylon loop carpet, as determined using ASTM D3936, of 7 psi or greater, for a 7.62 cm wide strip. The method can further include allowing the mixture to cure.

The carpet binder compositions can be used to adhere a primary backing to a face yarn. The method of using the composition can include binding the primary backing to the face yarn using a carpet binder composition disclosed herein. The face yarn can be selected from the group consisting of polyolefins, polyamides, polyesters, polyethylene terephthalate (PET), polytrimethylene terephthalate (PTT), natural fibers, and mixtures thereof. The method can further include binding a secondary backing to a surface of the primary backing using the carpet binder composition. The primary backing and the secondary backing can be selected from polyolefins, polyamides, natural fiber, and mixtures thereof, preferably comprising polypropylene fibers.

The details of one or more embodiments are set forth in the description below. Other features, objects, and advantages will be apparent from the description and from the claims.

### DETAILED DESCRIPTION

This disclosure is based on the discovery that particular copolymer latexes when formulated into carpet binder compositions provide superior dry and wet delamination strength. For example, it has been found that copolymer latexes, comprising a copolymerizable (reactive) surfactant during the emulsion polymerization process, formulated into carpet binder compositions provide superior dry and wet delamination strength. It has also been found that carpet binder compositions comprising styrene butadiene copolymer latexes having a portion of the styrene replaced with a hydrophilic monomer such as a (meth)acrylate monomer and/or a carboxylic acid monomer, also possess superior dry and especially wet delamination strength. Preferably, the (meth)acrylate monomer includes methyl methacrylate. Further, this disclosure is based on the discovery that copolymer latexes prepared in the presence of a reactive or non-reactive bulky phosphate surfactant (such as an aryl phosphate surfactant) during the emulsion polymerization process, formulated into carpet binder compositions provide superior dry and wet delamination strength. In addition, the carpet binder compositions prepared using the copolymer latexes and/or surfactants described herein exhibit desirable froth viscosities. As a result, such carpet binder compositions can be made at higher filler loadings resulting in significant cost savings.

Disclosed herein are copolymer latexes, compositions thereof, and methods of making and using the copolymer latexes and compositions. The copolymers disclosed herein can be derived from monomers comprising a vinyl aromatic monomer and a diene monomer. In certain embodiments, the copolymers can be further derived from an additional monomer selected from a copolymerizable surfactant, a methacrylate monomer, a carboxylic acid monomer, or a combination thereof.

Suitable vinyl aromatic monomers for use in the copolymers can include styrene or an alkyl styrene such as α- and p-methylstyrene, α-butylstyrene, p-n-butylstyrene, p-n-decylstyrene, vinyltoluene, and combinations thereof. The vinyl aromatic monomer can be present in an amount of 5% by weight or greater (e.g., 10% by weight or greater, 15% by weight or greater, 20% by weight or greater, 25% by weight or greater, 30% by weight or greater, 35% by weight or greater, 40% by weight or greater, 42% by weight or greater, 45% by weight or greater, 50% by weight or greater, 55% by weight or greater, 60% by weight or greater, 65% by weight or greater, or 70% by weight or greater), based on the total weight of monomers from which the copolymer is derived. In some embodiments, a vinyl aromatic monomer can be present in the copolymer in an amount of 80% by weight or less (e.g., 75% by weight or less, 70% by weight or less, 65% by weight or less, 60% by weight or less, 55% by weight or less, 50% by weight or less, 45% by weight or less, 40% by weight or less, 35% by weight or less, 30% by weight or less, 25% by weight or less, 20% by weight or less, 15% by weight or less, 10% by weight or less, or 5% by weight or less) based on the total weight of monomers from which the copolymer is derived. The copolymer can be derived from any of the minimum values to any of the maximum values by weight described above of the vinyl aromatic monomer. For example, the copolymer can be derived from 5% to 80% by weight (e.g., from 15% to 80%, from 15% to 60%, from 25% to 80%, from 25% to 60%, from 40% to 80%, from 40% to 75%, from 45% to 80%, from 45% to 70%, from 50% to 80%, or from 55% to 80% by weight of vinyl aromatic monomer), based on the total weight of monomers from which the copolymer is derived.

Suitable diene monomers present in the copolymer can include 1,2-butadiene (i.e. butadiene); conjugated dienes (e.g. 1,3-butadiene, 2-methyl-1,3-butadiene, 2-chloro-1,3-butadiene, and isoprene), or mixtures thereof. In some embodiments, the copolymer includes a 1,3-butadiene monomer. The diene monomer can be present in an amount of 5% by weight or greater (e.g., 10% by weight or greater, 15% by weight or greater, 20% by weight or greater, 25% by weight or greater, 30% by weight or greater, 35% by weight or greater, 40% by weight or greater, 42% by weight or greater, 45% by weight or greater, 50% by weight or greater, 55% by weight or greater, 60% by weight or greater, 65% by weight or greater, or 70% by weight or greater), based on the total weight of monomers from which the copolymer is derived. In some embodiments, diene monomer can be present in the copolymer in an amount of 80% by weight or less (e.g., 75% by weight or less, 70% by weight or less, 65% by weight or less, 60% by weight or less, 55% by weight or less, 50% by weight or less, 45% by weight or less, 40% by weight or less, 35% by weight or less, 30% by weight or less, 25% by weight or less, 20% by weight or less, 15% by weight or less, 10% by weight or less, or 5% by weight or less), based on the total weight of monomers from which the copolymer is derived. The copolymer can be derived from any of the minimum values to any of the maximum values by weight described above of the diene monomer. For example, the copolymer can be derived from 5% to 80% by weight (e.g., from 15% to 80%, from 15% to 60%, from 25% to 80%, from 25% to 60%, from 40% to 80%, from 40% to 75%, from 45% to 80%, from 45% to 70%, from 50% to 80%, or from 55% to 80% by weight of diene monomer), based on the total weight of monomers from which the copolymer is derived.

In addition to being derived from a vinyl aromatic monomer and a diene monomer, the copolymers disclosed herein can be further derived from an additional monomer selected from a copolymerizable surfactant, a methacrylate monomer, a carboxylic acid monomer, or a combination thereof. For example, the copolymers can be derived from a vinyl aromatic monomer, a diene monomer, and a copolymerizable surfactant. In other embodiments, the copolymers can be derived from a vinyl aromatic monomer, a diene monomer, and a methacrylate monomer. In further embodiments, the copolymers can be derived from a vinyl aromatic monomer, a diene monomer, and a carboxylic acid monomer. In still further embodiments, the copolymers can be derived from a vinyl aromatic monomer, a diene monomer, a copolymerizable surfactant, and a methacrylate monomer and/or a carboxylic acid monomer. Also disclosed herein are copolymers derived from a vinyl aromatic monomer and a diene monomer only.

When the additional monomer includes a copolymerizable surfactant, the copolymerizable surfactant reacts during polymerization and becomes part of the copolymer. In some embodiments, the copolymer is derived from 5% by weight or less of the copolymerizable surfactant (e.g., 4% by weight or less, 3% by weight or less, 2% by weight or less, 1.5% by weight or less, 1% by weight or less, or 0.5% by weight or less), based on the total weight of monomers from which the copolymer is derived. In some embodiments, the copolymer is derived from greater than 0% by weight of the copolymerizable surfactant (e.g., 0.1% or greater, 0.3% or greater, 0.5% or greater, 0.75% or greater, or 1% or greater by weight). In some embodiments, the copolymer is derived from 0.1% to 5% by weight or less of the copolymerizable surfactant (e.g., from 0.1% to 4% by weight, from 0.1% to 2.5% by weight, from 0.1% to 1.5% by weight, from 0.5% to 5% by weight, or from 1% to 4% by weight), based on the total weight of monomers from which the copolymer is derived.

The copolymerizable surfactants included in the copolymers can comprise an olefinically unsaturated group that can participate in a free radical polymerization can be used. Suitable polymerizable surfactants include hemi-esters of maleic anhydride of the formula M⁺—OOC—CH═CHCOOR wherein R is C₆₋₂₂ alkyl and M⁺ is Na⁺, K⁺, Li⁺, NH₄⁺, or a protonated or quaternary amine.

In some embodiments, the copolymerizable surfactant can be selected from an acrylic acid-modified polyoxyethylene alkyl ether, an acrylic acid-modified polyoxyethylene alkyl phenyl ether, an allylic acid-modified polyoxyethylene alkyl ether, an allylic acid-modified polyoxyethylene alkyl phenyl ether, an allylic acid-modified polyoxyethylene polystyrylphenyl ether, an acrylic acid-modified polyoxyethylene polystyrylphenyl ether, polyoxyethylene-polyoxypropylene glycol monoacrylate, and mixtures thereof.

In certain embodiments, the copolymerizable surfactants can have the formula I:

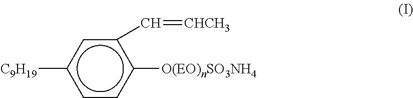

wherein n stands for a number of from 0 to 1,000. Exemplary copolymerizable surfactants can include the HITENOL® BC series (Dai-Ichi Kogyo Seiyaku Co., Ltd.), such as DC-10, BC-1025, BC-20, BD-2020, and BC-30.

In certain embodiments, copolymerizable surfactants suitable for use in the copolymer can have the formula II:

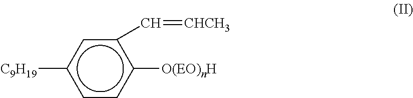

wherein n stands for a number of from 0 to 1,000. Exemplary copolymerizable surfactants can include the NOIGEN® RN series (Dai-Ichi Kogyo Seiyaku Co., Ltd.), such as RN-10, RN-20, RN-30, RN-40, and RN-5065.

In certain embodiments, copolymerizable surfactants suitable for use in the copolymer can have the formula III:

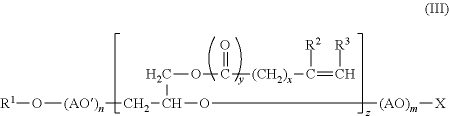

wherein R¹ represents a branched aliphatic hydrocarbon group, a secondary aliphatic hydrocarbon group or a branched aliphatic acyl group, AO and AO′ each independently represents an oxyalkylene group having 2 to 4 carbon atoms, R² and R³ each independently represents a hydrogen atom or a methyl group, x stands for a number of from 0 to 12, y stands for a number of 0 to 1, z stands for a number of from 1 to 10, X represents a hydrogen atom or an ionic hydrophilic group, m stands for a number of from 0 to 1,000, and n stands for a number of from 0 to 1,000. Suitable copolymerizable surfactants are described in U.S. Pat. No. 6,841,655, which is hereby incorporated by reference in its entirety.

In certain embodiments, the copolymerizable surfactants can be provided according to Formula IIIa:

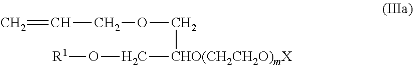

wherein R¹ is C₉-C₁₅ alkyl or C₇-C₁₁ alkyl-phenyl, X is H, SO₃NH₄ and/or SO₃Na, and m is 3 to 50. In some embodiments, R¹ is C₁₀-C₁₄ alkyl, X is H and/or SO₃NH₄, and m is 5 to 40. In some embodiments, m is 5 to 25, 5 to 20, or 5 to 15 (e.g., m=10). Exemplary copolymerizable surfactants wherein R¹ is C₁₀-C₁₄ alkyl can include ADEKA REASOAP series ER and SR surfactants (Asahi Denka Co., Ltd.), such as ER-10, ER-20, ER-30, ER-40, SR-10, SR-20, and SR-1025. For example, ADEKA REASOAP SR-10, which includes ammonium salts of poly(oxy-1,2-ethanediyl),alpha-sulfo-omega-[1-(hydroxymethyl)-2-(2-propenyloxy)ethoxy]-, C11-rich, C10-14-branched alkyl ethers, can be used. Exemplary copolymerizable surfactants in which R¹ is C₇-C₁₁ alkyl-phenyl can include ADEKA REASOAP series NE and SE surfactants, such as NE-10, NE-20, NE-30, NE-40, NE-50, SE-ION, SE-20N, and SE-1025N.

Other representative copolymerizable surfactants can include MAXEMUL™ 6112, MAXEMUL™ 5011, MAXEMUL™ 5010 (all available from Croda Industrial Specialties) and allylsulfosuccinate derivatives (such as TREM LT-40™ (available from Henkel)). In some embodiments, the copolymers do not include a copolymerizable surfactant.

The copolymer can be derived from a (meth)acrylate monomer. As used herein, “(meth)acryl . . . ” includes acryl . . . , methacryl . . . , diacryl . . . , and dimethacryl . . . . For example, the term “(meth)acrylate monomer” includes acrylate, methacrylate, diacrylate, and dimethacrylate monomers. The (meth)acrylate monomer can include esters of α,β-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C₁-C₂₀, C₄-C₂₀, C₁-C₁₆, or C₄-C₁₆ alkanols).

Exemplary (meth)acrylate monomers that can be used in the copolymers include methyl (meth)acrylate, allyl (meth)acrylate, ethyl (meth)acrylate, n-butyl (meth)acrylate, isobutyl (meth)acrylate, tert-butyl (meth)acrylate, isobutyl (meth)acrylate, n-hexyl (meth)acrylate, 2-ethylhexyl (meth)acrylate, n-heptyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, heptadecyl (meth)acrylate, lauryl (meth)acrylate, tridecyl (meth)acrylate, stearyl (meth)acrylate, glycidyl (meth)acrylate, allyl (meth)acrylate, tetrahydrofurfuryl (meth)acrylate, cyclohexyl (meth)acrylate, 2-propylheptyl (meth)acrylate, behenyl (meth)acrylate, cyclohexyl methacrylate, t-butyl acrylate, t-butyl methacrylate, stearyl methacrylate, behenyl methacrylate, allyl methacrylate, or combinations thereof.

The copolymers can be derived from 0% by weight to 30% by weight or less of one or more (meth)acrylate monomers (e.g., 30% by weight or less, 25% by weight or less, 20% by weight or less, 18% by weight or less, 15% by weight or less, 12% by weight or less, 10% by weight or less, 8% by weight or less, 7% by weight or less, 6% by weight or 5% by weight or less, 4% by weight or less, 3% by weight or less, 2% by weight or less, 1% by weight or less, or 0% by weight of the (meth)acrylate monomer) based on the total weight of monomers from which the copolymer is derived. The copolymers can be derived from 0% or greater (e.g., 0.1% or greater, 0.5% or greater, 1% or greater, 2.5% or greater, 5% or greater, 7% or greater, 10% or greater, 12.5% or greater, 15% or greater, 18% or greater, 20% or greater, 22% or greater, 25% or greater, or up to 30%) by weight of one or more (meth)acrylate monomers, based on the total weight of monomers from which the copolymer is derived. In certain embodiments, the copolymer can be derived from 0% to 30% by weight, from 0.5% by weight to 30% by weight, from 0.5% to 25% by weight, from 0.5% by weight to 20%, from 0.5% to 15% by weight, from 0.5% to 10% by weight, from 1.5% to 15% by weight, by weight of one or more (meth)acrylate monomers, based on the total weight of monomers from which the copolymer is derived.

Preferably, the copolymer includes a hydrophilic (meth)acrylate monomer. As used herein, “hydrophilic” refers to a monomer having a water solubility of greater than 0.5 g/100 g water at 20° C. For example, the solubility of the hydrophilic monomers in water, measured at 20° C., can be 1.0 g/100 g water or greater, 1.5 g/100 g water or greater, 2.0 g/100 g water or greater, 2.5 g/100 g water or greater, 3.0 g/100 g water or greater, 3.5 g/100 g water or greater, 4.0 g/100 g water or greater, or 4.5 g/100 g water or greater. Suitable hydrophilic monomers include as noted herein methyl methacrylate (1.5 g/100 g water) and ethyl methacrylate (0.5 g/100 g water). Solubilities can be provided, e.g., from D. R. Bassett, “Hydrophobic Coatings for Emulsion Polymers,” Journal of Coatings Technology, January 2001, or High Polymers Vol. IX: Emulsion Polymerization, F. A. Bovey, I. M. Kolthoff, A. I. Medalia and E. J. Meehan, p. 156, 1954. The hydrophilic monomers as polymerized units can provide compositions with improved resistance to moisture.

In some embodiments, at least 0.10% by weight of the monomers in the copolymer can be hydrophilic monomers, that is, monomers having a water solubility of 0.5 g/100 g water or greater at 20° C. For example, at least 0.3% by weight (e.g., at least 0.5%, at least 0.8%, at least 1%, at least 1.5%, at least 2.0%, at least 2.5%, at 3.0%, at least 3.5%, at least 5%, at least 8%, at least 10%, at least 15%, from 0.1% to 10%, from 0.5% to 10%, from 0.5% to 5%, from 0.5% to 3%, or from 0.5% to 2.5%) of the monomers in the copolymers can have a water solubility of greater than 0.5 g/100 g water at 20° C. (e.g., 0.8 g/100 g water or greater, 1.0 g/100 g water or greater, 1.2 g/100 g water or greater, 1.5 g/100 g water or greater, 1.8 g/100 g water or greater, 2.0 g/100 g water or greater, or 2.5 g/100 g water or greater).

Exemplary hydrophilic (meth)acrylate monomers include methyl methacrylate. In some embodiments, the copolymer can be derived from 30% or less (e.g., 25% or less, 20% or less, 18% or less, 15% or less, 13% or less, 12% or less, 10% or less, 9% or less, 8% or less, 7% or less, 6% or less, 5% or less, 4% or less, 3.5% or less, 3% or less, 2.5% or less, 2% or less, 1.5% or less, or 1% or less) by weight of methyl methacrylate, based on the total weight of monomers from which the copolymer is derived. In some embodiments, the copolymer can be derived from greater than 0% (e.g., 0.1% or greater, 0.3% or greater, 0.5% or greater, 1% or greater, 1.5% or greater, 2% or greater, 2.5% or greater, 3% or greater, 3.5% or greater, 4% or greater, 5% or greater, 6% or greater, 7% or greater, 8% or greater, 9% or greater, 10% or greater, 12% or greater, 15% or greater, 18% or greater, 20% or greater, 25% or greater, or 30% or greater) by weight of methyl methacrylate, based on the total weight of monomers from which the copolymer is derived. In certain embodiments, the copolymer can be derived from 0.1% to 30% by weight, from 1% to 25% by weight, from 5% to 25% by weight, from 8% to 15% by weight, from 0.1% to 10% by weight, from 0.5% by weight to 5% by weight or from 0.5% by weight to 3.5% by weight of one or more methyl methacrylate, based on the total weight of monomers from which the copolymer is derived.

The copolymers disclosed herein can be further derived from an acid monomer. The acid monomer can include a carboxylic acid-containing monomer. Examples of carboxylic acid-containing monomers include α,β-monoethylenically unsaturated mono- and dicarboxylic acids. In some embodiments, the one or more carboxylic acid-containing monomers can be selected from the group consisting of acrylic acid, methacrylic acid, itaconic acid, maleic acid, fumaric acid, crotonic acid, dimethacrylic acid, ethylacrylic acid, allylacetic acid, vinylacetic acid, mesaconic acid, methylenemalonic acid, styrene carboxylic acid, citraconic acid, and combinations thereof.

The copolymer can be derived from 5% or less (e.g., 4.5% or less, 4% or less, 3.5% or less, 3% or less, 2.5% or less, 2% or less, 1.5% or less, or 1% or less) by weight of carboxylic acid-containing monomers, based on the total weight of monomers from which the copolymer is derived. In some embodiments, the copolymer can be derived from greater than 0% (e.g., 0.1% or greater, 0.3% or greater, 0.5% or greater, 1% or greater, 1.5% or greater, 2% or greater, 2.5% or greater, 3% or greater, 3.5% or greater, or 4% or greater) by weight of carboxylic acid-containing monomers, based on the total weight of monomers from which the copolymer is derived. In certain embodiments, the copolymer can be derived from 0.1% to 5% by weight, 0.1% to 4% by weight, from 0.5% by weight to 4% by weight or from 0.5% by weight to 3.5% by weight of one or more carboxylic acid-containing monomers, based on the total weight of monomers from which the copolymer is derived.

The copolymer can be derived from one or more further monomers. In some embodiments, the one or more further monomers can include an organosilane monomer. The organosilane monomer can be defined by the general Formula IV below:

(R¹)—(Si)—(OR²)₃ (IV)

wherein R¹ is a C₁-C₈ substituted or unsubstituted alkyl or a C₁-C₈ substituted or unsubstituted alkene and each of R² is independently a C₁-C₈ substituted or unsubstituted alkyl group. Suitable silane containing monomers can include, for example, vinyl silanes such as vinyltrimethoxysilane, vinyltriethoxysilane (VTEO), vinyl tris(2-methoxyethoxysilane), and vinyl triisopropoxysilane, and (meth)acrylatoalkoxysilanes, such as (meth)acryloyloxypropyltrimethoxysilane, γ-(meth)acryloxypropyltrimethoxysilane, γ-(meth)acryloxypropyltriethoxysilane, or a combination thereof.

In some embodiments, the organosilane monomer can include a multivinyl siloxane oligomer. Multivinyl siloxane oligomers are described in U.S. Pat. No. 8,906,997, which is hereby incorporated by reference in its entirety. The multivinyl siloxane oligomer can include oligomers having a Si—O—Si backbone. For example, the multivinyl siloxane oligomer can have a structure represented by the Formula V below:

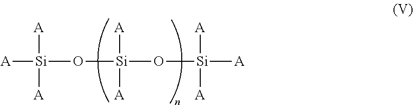

wherein each of the A groups are independently selected from hydrogen, hydroxy, alkoxy, substituted or unsubstituted C₁₋₄ alkyl, or substituted or unsubstituted C₂₋₄ alkenyl and n is an integer from 1 to 50 (e.g., 10). As used herein, the terms “alkyl” and “alkenyl” include straight- and branched-chain monovalent substituents. Examples include methyl, ethyl, propyl, butyl, isobutyl, vinyl, allyl, and the like. The term “alkoxy” includes alkyl groups attached to the molecule through an oxygen atom. Examples include methoxy, ethoxy, and isopropoxy.

In some embodiments, at least one of the A groups in the repeating portion of Formula V are vinyl groups. The presence of multiple vinyl groups in the multivinyl siloxane oligomers enables the oligomer molecules to act as crosslinkers in compositions comprising the copolymers. In some examples, the multivinyl siloxane oligomer can have the following structure represented by Formula Va below:

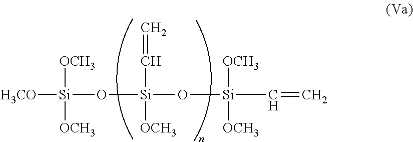

In Formula Va, n is an integer from 1 to 50 (e.g., 10). Further examples of suitable multivinyl siloxane oligomers include DYNASYLAN 6490, a multivinyl siloxane oligomer derived from vinyltrimethoxysilane, and DYNASYLAN 6498, a multivinyl siloxane oligomer derived from vinyltriethoxysilane, both commercially available from Evonik Degussa GmbH (Essen, Germany). Other suitable multivinyl siloxane oligomers include VMM-010, a vinylmethoxysiloxane homopolymer, and VEE-005, a vinylethoxysiloxane homopolymer, both commercially available from Gelest, Inc. (Morrisville, Pa.).

When present, the copolymer can include from greater than 0% by weight to 5% by weight of the organosilane monomer, based on the total weight of monomers from which the copolymer is derived. In certain embodiments, the copolymer can be derived from greater than 0% by weight to 2.5% by weight of the organosilane monomer, based on the total weight of monomers from which the copolymer is derived. In some embodiments, the copolymer is derived from 5% or less, 4% or less, 3.5% or less, 3% or less, 2.5% or less, 2% or less, or 1% or less by weight of the organosilane monomer, based on the total weight of monomers from which the copolymer is derived. In some embodiments, the copolymer is derived from 0.1% or greater, 0.3% or greater, 0.5% or greater, 0.75% or greater, or 1% or greater by weight of the organosilane monomer, based on the total weight of monomers from which the copolymer is derived.

In some embodiments, the copolymer includes a (meth)acrylamide or a derivative thereof. The (meth)acrylamide derivative include, for example, keto-containing amide functional monomers defined by the general Formula VI below

CH₂═CR₁C(O)NR₂C(O)R₃ (VI)

wherein R₁ is hydrogen or methyl; R₂ is hydrogen, a C₁-C₄ alkyl group, or a phenyl group; and R₃ is hydrogen, a C₁-C₄ alkyl group, or a phenyl group. For example, the (meth)acrylamide derivative can be diacetone acrylamide (DAAM) or diacetone methacrylamide. Suitable acetoacetoxy monomers that can be included in the copolymer include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Sulfur-containing monomers that can be included in the copolymer include, for example, sulfonic acids and sulfonates, such as vinylsulfonic acid, 2-sulfoethyl methacrylate, sodium styrenesulfonate, 2-sulfoxyethyl methacrylate, vinyl butylsulfonate, sulfones such as vinylsulfone, sulfoxides such as vinylsulfoxide, and sulfides such as 1-(2-hydroxyethylthio) butadiene. Examples of suitable phosphorus-containing monomers that can be included in the copolymer include dihydrogen phosphate esters of alcohols in which the alcohol contains a polymerizable vinyl or olefenic group, allyl phosphate, phosphoalkyl(meth)acrylates such as 2-phosphoethyl(meth)acrylate (PEM), 2-phosphopropyl(meth)acrylate, 3-phosphopropyl (meth)acrylate, and phosphobutyl(meth)acrylate, 3-phospho-2-hydroxypropyl(meth)acrylate, mono- or di-phosphates of bis(hydroxymethyl) fumarate or itaconate; phosphates of hydroxyalkyl(meth)acrylate, 2-hydroxyethyl(meth)acrylate, 3-hydroxypropyl(meth)acrylate, ethylene oxide condensates of (meth)acrylates, H₂C═C(CH₃)COO(CH₂CH₂O)ₙP(O)(OH)₂, and analogous propylene and butylene oxide condensates, where n is an amount of 1 to 50, phosphoalkyl crotonates, phosphoalkyl maleates, phosphoalkyl fumarates, phosphodialkyl (meth)acrylates, phosphodialkyl crotonates, vinyl phosphonic acid, allyl phosphonic acid, 2-acrylamido-2-methylpropanephosphinic acid, 2-acrylamido-2-methyl propane sulfonic acid or a salt thereof (such as sodium, ammonium, or potassium salts), α-phosphonostyrene, 2-methylacrylamido-2-methylpropanephosphinic acid, (hydroxy)phosphinylalkyl(meth)acrylates, (hydroxy)phosphinylmethyl methacrylate, and combinations thereof. In some embodiments, the copolymer includes 2-acrylamido-2-methyl propane sulfonic acid. Hydroxy (meth)acrylates that can be included in the copolymer include, for example, hydroxyl functional monomers defined by the general Formula VII below

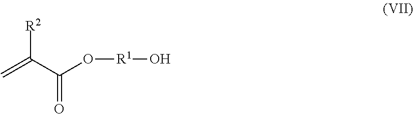

wherein R¹ is hydrogen or methyl and R₂ is hydrogen, a C₁-C₄ alkyl group, or a phenyl group. For example, the hydroxyl (meth)acrylate can include hydroxypropyl (meth)acrylate, hydroxybutylacrylate, hydroxybutylmethacrylate, hydroxyethylacrylate (HEA) and hydroxyethylmethacrylate (HEMA).

Other suitable further monomers that can be included in the copolymer include (meth)acrylonitrile, vinyl halide, vinyl ether of an alcohol comprising 1 to 10 carbon atoms, aliphatic hydrocarbon having 2 to 8 carbon atoms and one or two double bonds, phosphorus-containing monomer, acetoacetoxy monomer, sulfur-based monomer, hydroxyl (meth)acrylate monomer, methyl (meth)acrylate, ethyl (meth)acrylate, alkyl crotonates, di-n-butyl maleate, di-octylmaleate, acetoacetoxyethyl (meth)acrylate, acetoacetoxypropyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2 ethoxyethoxy)ethyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, 2,3-di(acetoacetoxy)propyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, or combinations thereof.

In some embodiments, the copolymer includes a crosslinking monomer. For example, the crosslinking monomer can include diacetone acrylamide (DAAM) or a self-crosslinking monomer such as a monomer comprising 1,3-diketo groups or a silane crosslinker. Examples of monomers comprising 1,3-diketo groups include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Examples of suitable silane crosslinkers include 3-methacryloxypropyl trimethoxysilane, 3-mercaptopropyl trimethoxysilane, vinyl-triethoxysilane, and polyvinyl-siloxane oligomers such as DYNASYLAN 6490, a polyvinyl siloxane oligomer derived from vinyltrimethoxysilane, and DYNASYLAN 6498, a polyvinyl siloxane oligomer derived from vinyltriethoxysilane, both commercially available from Evonik Degussa GmbH (Essen, Germany). Crosslinking monomers as described herein can further include monomers such as divinylbenzene; 1,4-butanediol diacrylate; methacrylic acid anhydride; and monomers containing urea groups (e.g., ureidoethyl (meth)acrylate, acrylamidoglycolic acid, and methacrylamidogly colate methyl ether. Additional examples of crosslinkable monomers include N-alkylolamides of α,β-monoethylenically unsaturated carboxylic acids having 3 to 10 carbon atoms and esters thereof with alcohols having 1 to 4 carbon atoms (e.g., N-methylolacrylamide and N-methylolmethacrylamide); glyoxal based crosslinkers; monomers containing two vinyl radicals; monomers containing two vinylidene radicals; and monomers containing two alkenyl radicals. Exemplary crosslinking monomer include diesters or triesters of dihydric and trihydric alcohols with α,β-monoethylenically unsaturated monocarboxylic acids (e.g., di(meth)acrylates, tri(meth)acrylates), of which in turn acrylic acid and methacrylic acid can be employed. Examples of such monomers containing two non-conjugated ethylenically unsaturated double bonds are alkylene glycol diacrylates and dimethacrylates, such as ethylene glycol diacrylate, 1,3-butylene glycol diacrylate, 1,4-butylene glycol diacrylate and propylene glycol diacrylate, vinyl methacrylate, vinyl acrylate, allyl methacrylate, allyl acrylate, diallyl maleate, diallyl fumarate and methylenebisacrylamide.

The one or more further monomers can include a (meth)acrylate monomer, a (meth)acrylonitrile monomer, a (meth)acrylamide monomer, an organosilane, a crosslinking monomer, a glycidyl (meth)acylate, or a combination thereof.

When present, the one or more further monomers can be present in small amounts (e.g., 10% by weight or less, 7.5% by weight or less, 5% by weight or less, 4% by weight or less, 3% by weight or less, 2% by weight or less, 1.5% by weight or less, 1% by weight or less, or 0.5% by weight or less), based on the total weight of monomers from which the copolymer is derived. The one or more further monomers when present can be present in an amount of greater than 0%, 0.1% by weight or greater, 0.3% or greater, 0.5% or greater, 0.75% or greater, or 1% or greater by weight, based on the total weight of monomers from which the copolymer is derived.

In some examples, the copolymers disclosed herein can include 40% to 80% by weight styrene, 15% to 55% by weight of butadiene, 0.1% to 5% by weight of the additional monomer selected from a copolymerizable surfactant, methyl methacrylate, acrylic acid, or a combination thereof, and 0% to 4% by weight of one or more further monomers selected from an additional (meth)acrylate monomer, a (meth)acrylonitrile monomer, a (meth)acrylamide monomer, an organosilane, a crosslinking monomer, glycidyl (meth)acylate, or a combination thereof.

The copolymers described herein can have a theoretical glass-transition temperature (Tg) and/or a Tg as measured by differential scanning calorimetry (DSC) using the mid-point temperature using the method described, for example, in ASTM 3418/82, of 80° C. or less (e.g., 75° C. or less, 70° C. or less, 65° C. or less, 60° C. or less, 55° C. or less, 50° C. or less, 45° C. or less, 40° C. or less, 35° C. or less, 30° C. or less, 25° C. or less, 20° C. or less, 15° C. or less, 12° C. or less, 10° C. or less, 5° C. or less, 0° C. or less, −5° C. or less, −10° C. or less, −15° C. or less, −20° C. or less, −25° C. or less, or −30° C. or less). The copolymers can have a theoretical Tg and/or a Tg as measured by DSC using the mid-point temperature using the method described, for example, in ASTM 3418/82, of −40° C. or greater (e.g., −35° C. or greater, −30° C. or greater, −25° C. or greater, −20° C. or greater, −15° C. or greater, −10° C. or greater, −5° C. or greater, 0° C. or greater, 5° C. or greater, 10° C. or greater, 15° C. or greater, 20° C. or greater, 25° C. or greater, 30° C. or greater, 35° C. or greater, 40° C. or greater, 45° C. or greater, 50° C. or greater, 55° C. or greater, 60° C. or greater, 65° C. or greater, 70° C. or greater, or 75° C. or greater). The copolymers can have a theoretical Tg and/or a Tg as measured by DSC using the mid-point temperature using the method described, for example, in ASTM 3418/82, ranging from any of the minimum values described above to any of the maximum values described above. For example, the copolymers can have a theoretical glass-transition temperature (Tg) and/or a Tg as measured by differential scanning calorimetry (DSC) using the mid-point temperature using the method described, for example, in ASTM 3418/82, of from −40° C. to 80° C. (e.g., from −40° C. to 60° C., from −30° C. to 80° C., from −30° C. to 70° C., from −20° C. to 80° C., from −20° C. to 70° C., from −20° C. to 60° C., from −10° C. to 80° C., from −10° C. to 60° C., from −5° C. to 60° C., from −5° C. to 50° C., from 0° C. to 60° C., from 0° C. to 55° C., or from greater than 0° C. to 80° C.).

The theoretical glass transition temperature or “theoretical T_{g}” of the copolymer refers to the estimated T_{g} calculated using the Fox equation. The Fox equation can be used to estimate the glass transition temperature of a polymer or copolymer as described, for example, in L. H. Sperling, “Introduction to Physical Polymer Science”, 2^{nd} Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, . . . , and i can be calculated according to the equation below

$$\frac{1}{{T}_{g}} = \frac{{w}_{a}}{{T}_{g a}} + \frac{{w}_{b}}{{T}_{g b}} + … + \frac{{w}_{i}}{{T}_{g i}}$$

where wₐ is the weight fraction of monomer a in the copolymer, T_{g}a is the glass transition temperature of a homopolymer of monomer a, w_{b} is the weight fraction of monomer b in the copolymer, T_{gb} is the glass transition temperature of a homopolymer of monomer b, wᵢ is the weight fraction of monomer i in the copolymer, T_{gi} is the glass transition temperature of a homopolymer of monomer i, and T_{g} is the theoretical glass transition temperature of the copolymer derived from monomers a, b, . . . , and i.

The copolymers can comprise particles having a small particle size. In some embodiments, the copolymers can comprise particles having a number average particle size of 300 nm or less (e.g., 280 nm or less, 270 nm or less, 250 nm or less, 230 nm or less, 210 nm or less, 200 nm or less, 180 nm or less, 160 nm or less, 150 nm or less, 140 nm or less, 130 nm or less, 120 nm or less, 110 nm or less, 100 nm or less, 95 nm or less, 90 nm or less, or 85 nm or less). In some embodiments, the copolymers can have a number average particle size of 10 nm or greater, 20 nm or greater, 30 nm or greater, 35 nm or greater, 40 nm or greater, 45 nm or greater, 50 nm or greater, 55 nm or greater, 60 nm or greater, 65 nm or greater, 80 nm or greater, 100 nm or greater, 120 nm or greater, 130 nm or greater, 140 nm or greater, 150 nm or greater, 160 nm or greater, 180 nm or greater, 200 nm or greater, 220 nm or greater, 250 nm or greater, or 280 nm or greater. In some embodiments, the copolymers can have a number average particle size of from 10 nm to 300 nm, from 10 nm to 250 nm, from 10 nm to 220 nm, 10 nm to 200 nm, from 10 nm to 180 nm, from 10 nm to 150 nm, from 10 nm to 130 nm, from 10 nm 120 nm, 10 nm to 100 nm, from 10 nm to less than 100 nm, from 20 nm to 300 nm, from 20 nm to 250 nm, from 30 nm to 250 nm, from 40 nm to 250 nm, from 40 nm to 200 nm, or from 40 nm to 150 nm. In some embodiments, the copolymers can have a volume average particle size of from 10 nm to 300 nm, from 10 nm to 250 nm, 10 nm to 220 nm, 10 nm to 200 nm, from 10 nm to 180 nm, from 10 nm to 150 nm, from 10 nm to 130 nm, from 10 nm 120 nm, 10 nm to 100 nm, or from 10 nm to less than 100 nm. The ratio between the volume average particle size (in nm) and the number average particle size (in nm) can be from 1.0 to 1.2 or from 1.0 to 1.1. The particle size can be determined using dynamic light scattering measurements using the Nanotrac Wave II Q available from Microtrac Inc., Montgomeryville, Pa.

In some embodiments, the weight average molecular weight of the copolymers can be greater than 1,000,000 Da. As described herein, the molecular weight of the copolymers can be adjusted by the amount of chain transfer agent added during polymerization, such that the weight average molecular weight of the copolymers is less than 1,000,000 Da. In some embodiments, the weight average molecular weight of the copolymers can be 10,000 Da or greater (e.g., 20,000 Da or greater, 50,000 Da or greater, 75,000 Da or greater, 100,000 Da or greater, 150,000 Da or greater, 200,000 Da or greater, 300,000 Da or greater, 400,000 Da or greater, 500,000 Da or greater, 600,000 Da or greater, 700,000 Da or greater, 800,000 Da or greater, 900,000 Da or greater, or 1,000,000 Da or greater). In some embodiments, the weight average molecular weight of the copolymers can be 1,000,000 Da or less (e.g., 900,000 Da or less, 800,000 Da or less, 700,000 Da or less, 600,000 Da or less, 500,000 Da or less, 400,000 Da or less, 300,000 Da or less, 200,000 Da or less, 150,000 Da or less, 100,000 Da or less, 75,000 Da or less, or 50,000 Da or less). In some embodiments, the weight average molecular weight of the copolymers can be from 100,000 Da to 1,000,000 Da.

In some embodiments, the copolymer composition disclosed herein is a gel. Polymerization of the monomers in the absence of the chain transfer agent tend to increase the gel content of the resulting copolymer. In some embodiments, the chain transfer agent can be present in an amount sufficient to reduce the gel content of the copolymer by 5% or greater (for example, 8% or greater, 10% or greater, 15% or greater, 20% or greater, or 25% or greater), compared to a copolymer polymerized using identical monomers in the absence of the chain transfer agent.

In some embodiments, the copolymer compositions disclosed herein have a gel content of from 0% to 95% (e.g., from 5% to 95% or from 10% to 95%). The gel content of the copolymer compositions can depend on the molecular weight of the copolymers in the composition. In certain embodiments, the copolymer compositions have a gel content of 5% or greater, 10% or greater, 15% or greater, 20% or greater, 30% or greater, 40% or greater, 50% or greater, 60% or greater, 75% or greater, 80% or greater, 85% or greater, or 90% or greater. In certain embodiments, the copolymer compositions have a gel content of 95% or less, 85% or less, 75% or less, 70% or less, 65% or less, 60% or less, 55% or less, or 50% or less.

The copolymers can be produced as a dispersion that includes, as a disperse phase, particles of the copolymers dispersed in water. The copolymers can be present in the dispersion in varying amounts so as to provide a resultant composition with the desired properties for a particular application. For example, the copolymer dispersion can be prepared with a total solids content of from 20% to 70% by weight (e.g., 25% to 65% by weight, 35% to 60% by weight, or 40% to 55% by weight). In some embodiments, the copolymer dispersion can have a total solids content of 40% or greater by weight.

As described herein, the monomers in the copolymer can be polymerized in the presence of an aryl phosphate surfactant. The composition can include greater than 0% by weight of one or more aryl phosphate surfactants, based on the total weight of all components of the composition (e.g., at least 0.1% by weight, at least 0.2% by weight, at least 0.3% by weight, at least 0.5% by weight, at least 1% by weight, at least 1.5% by weight, at least 2% by weight, at least 2.5% by weight, at least 3% by weight, at least 3.5% by weight, at least 4% by weight, at least 4.5% by weight, or at least 5% by weight). The composition can include 5% or less of one or more aryl phosphate surfactants, based on the total weight of all components of the composition (e.g., 4.5% or less by weight, 4% or less by weight, 3.5% or less by weight, 3% or less by weight, 2.5% or less by weight, 2% or less by weight, 1.5% or less by weight, 1% or less by weight, 0.5% or less by weight, 0.4% or less by weight, or 0.3% or less by weight). The composition can include one or more aryl phosphate surfactants in an amount ranging from any of the minimum percentages described above to any of the maximum percentages described above. For example, the composition can include from greater than 0% by weight to 5% by weight of one or more aryl phosphate surfactants, based on the total weight of all components of the composition (e.g., from greater than 0% to 4%, from 0.1% to 3.5%, from 0.5% to 3.5%, or from 0.5% to 2.5%).

The aryl phosphate surfactant can be an alkoxylated polyarylphenol phosphate ester of the formula (VIII):

CₓH_{y}—O-(AO)ₙ—PO₄²⁻ (VIII)

wherein AO represents an oxyalkylene group having 2 to 4 carbon atoms; CₓH_{y} represents one or more substituted or unsubstituted aryl groups wherein x is an integer 20 or greater, 30 or greater, from 30 to 40, and y is an integer 14 or greater, 24 or greater, from 14 to 34; and n is an integer 1 or greater, 10 or greater, or from 10 to 150.

In some embodiments, the aryl phosphate surfactant can be an alkoxylated polyarylphenol phosphate ester of the formula (VIIIa):

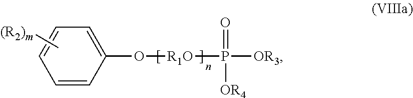

wherein R₁ independently is a straight chain or branched C₂-C₄ alkylene, R₂ is aryl or alkylaryl, wherein R₂ is unsubstituted or substituted by one to three groups selected from the group consisting of C₁-C₄ alkyl or C₁-C₄ alkoxy, and R₃ and R₄ are independently selected from the group consisting of hydrogen, sodium, potassium, ammonium, and

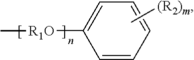

m, is 2 or 3, and n is a number from 1 to 150 inclusive.

In certain embodiments, the aryl phosphate surfactant can comprise a tristyrylphenol alkoxylated phosphate. Suitable tristyrylphenol alkoxylated phosphates include surfactants defined by Formula IX below

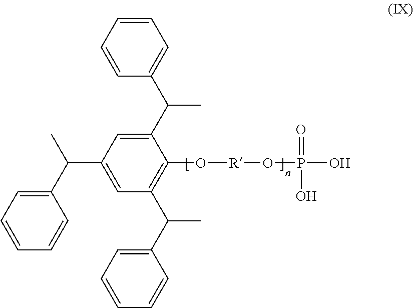

or a salt thereof, wherein R′ comprises a C₁-C₆ alkylene group, and n is an integer ranging from 1 to 50 (e.g., from 1 to 25, from 10 to 20, or from 14 to 18). In certain embodiments, the composition comprises a tristyrylphenol alkoxylated phosphate defined by Formula IX or a salt thereof, wherein R′ comprises an ethylene group, and n is an integer ranging from 10 to or from 14 to 18. In certain embodiments, the composition includes the tristyrylphenol alkoxylated phosphate defined by Formula IXa shown below

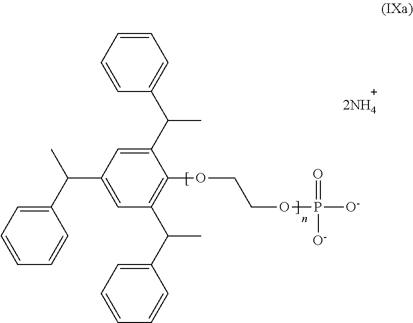

wherein n is 16.

In addition to the phosphate surfactant, the dispersion can include additional surfactants (emulsifiers). The additional surfactant can include nonionic surfactants, anionic surfactants, cationic surfactants, amphoteric surfactants, or a mixture thereof. In some embodiments, the additional surfactant can include oleic acid surfactants, alkyl sulfate surfactants, alkyl aryl disulfonate surfactants, or alkylbenzene sulfonic acid or sulfonate surfactants. Exemplary surfactant can include ammonium lauryl sulfate, sodium laureth-1 sulfate, sodium laureth-2-sulfate, and the corresponding ammonium salts, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium lauryl sarcosinate, sodium lauroyl sarcosinate, lauryl sarcosine, cocyl sarcosine, ammonium cocoyl sulfate, ammonium lauroyl sulfate, sodium cocoyl sulfate, sodium lauroyl sulfate, potassium cocoyl sulfate, monoethanolamine cocoyl sulfate, monoethanolamine lauryl sulfate, sodium tridecyl benzene sulfonate, sodium dodecyl benzene sulfonate, C12 (branched) sodium diphenyl oxide disulfonate, or combinations thereof. Examples of commercially available surfactants include Calfoam® ES-303, a sodium laureth sulfate, and Calfax® DB-45, a sodium dodecyl diphenyl oxide disulfonate, both available from Pilot Chemical Company (Cincinnati, Ohio), Disponil SDS, Polystep LAS-40, or combinations thereof. The amount of the additional surfactant employed can be from 0.01 to 5%, based on the total amount of the monomers to be polymerized. In some embodiments, the surfactant is provided in an amount less than 2% by weight. The additional surfactant can be included during polymerization of the copolymer. For example, the additional surfactant can be provided in the initial charge of the reactor, provided in the monomer feed stream, provided in an aqueous feed stream, provided in a pre-emulsion, provided in the initiator stream, or a combination thereof. The additional surfactant can also be provided as a separate continuous stream to the reactor.

The monomers in the copolymer can be polymerized in the presence of a chain transfer agent. A “chain transfer agent” as used herein refers to chemical compounds that are useful for controlling the molecular weights of polymers, for reducing gelation when polymerizations and copolymerizations involving diene monomers are conducted, and/or for preparing polymers and copolymers with useful chemical functionality at their chain ends. The chain transfer agent reacts with a growing polymer radical, causing the growing chain to terminate while creating a new reactive species capable of initiating polymerization. The phrase “chain transfer agent” is used interchangeably with the phrase “molecular weight regulator.”

Suitable chain transfer agents that can be used during polymerization of the copolymers disclosed herein can include compounds having a carbon-halogen bond, a sulfur-hydrogen bond, a silicon-hydrogen bond, or a sulfur-sulfur bond; an allyl alcohol, or an aldehyde. In some embodiments, the chain transfer agents contain a sulfur-hydrogen bond and are known as mercaptans. In some embodiments, the chain transfer agent can include C₃-C₂₀ mercaptans. Specific examples of the chain transfer agent can include octyl mercaptan such as n-octyl mercaptan and t-octyl mercaptan, decyl mercaptan, tetradecyl mercaptan, hexadecyl mercaptan, dodecyl mercaptan such as n-dodecyl mercaptan and t-dodecyl mercaptan, tert-butyl mercaptan, mercaptoethanol such as β-mercaptoethanol, 3-mercaptopropanol, mercaptopropyltrimethoxysilane, tert-nonyl mercaptan, tert-dodecyl mercaptan, 6-mercaptomethyl-2-methyl-2-octanol, 4-mercapto-3-methyl-1-butanol, methyl-3-mercaptopropionate, butyl-3-mercaptopropionate, i-octyl-3-mercaptopropionate, i-decyl-3-mercaptopropionate, dodecyl-3-mercaptopropionate, octadecyl-3-mercaptopropionate, and 2-phenyl-1-mercapto-2-ethanol. Other suitable examples of chain transfer agents that can be used during polymerization of the copolymers include thioglycolic acid, methyl thioglycolate, n-butyl thioglycolate, i-octyl thioglycolate, dodecyl thioglycolate, octadecyl thioglycolate, ethylacrylic esters, terpinolene. In some examples, the chain transfer agent can include tert-dodecyl mercaptan.

The amount of chain transfer agent utilized during polymerization can be in an effective amount to reduce the glass transition temperature (Tg) of the copolymer, compared to a copolymer polymerized using identical monomers in the absence of a chain transfer agent. That is, polymerization of the monomers in the absence of the chain transfer agent tend to increase the glass transition temperature of the resulting copolymer. In some embodiments, the chain transfer agent can be in an effective amount to reduce the glass transition temperature of the copolymer by at least 5° C., compared to a copolymer polymerized using identical monomers in the absence of a chain transfer agent.

The amount of chain transfer agent used in the polymerization reaction can be present in an amount of at least 1 part per hundred monomers present in the copolymer. For example, the chain transfer agent can be present in an amount of 1.2 parts or greater, 1.5 parts or greater, 2 parts or greater, or 2.5 parts or greater per hundred monomers present in the copolymer during polymerization. In some embodiments, the chain transfer agent can be present in an amount of 4 parts or less, 3.5 parts or less, 3 parts or less, or 2.5 parts or less per hundred monomers present in the copolymer during polymerization. In some embodiments, the chain transfer agent can be present in an amount from 1 part to 4 parts, from 1.5 parts to 4 parts, from 1 part to 3.5 parts, from 1.5 parts to 3.5 parts, from 1 part to 3 parts, from 1.5 parts to 3 parts, or from 1 part to 2.5 parts per hundred monomers present in the copolymer during polymerization. When the chain transfer agent is used, the resulting copolymer can contain from about 0.01% to about 4%, from about 0.05% to about 4%, from about 0.1% to about 4%, or from about 0.1% to about 3.5% by weight of the chain transfer agent.

As disclosed herein, the copolymers can be used in coating formulations, particularly carpet binder formulations. The carpet binder formulations can further include one or more additives such as one or more coalescing aids/agents (coalescents), plasticizers, defoamers, additional surfactants, pH modifying agents, fillers, mineral filler (pigments), dispersing agents, thickeners, biocides, crosslinking agents (e.g., quick-setting additives, for example, polyamines such as polyethyleneimine), flame retardants, stabilizers, corrosion inhibitors, flattening agents, optical brighteners and fluorescent additives, curing agents, flow agents, wetting or spreading agents, leveling agents, hardeners, or combinations thereof. In some embodiments, the additive can be added to impart certain properties to the coating such as smoothness, whiteness, increased density or weight, decreased porosity, increased opacity, flatness, glossiness, decreased blocking resistance, barrier properties, and the like.

Suitable coalescing aids, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, propylene glycol n-butyl ether, dipropylene glycol n-butyl ether, 2,2,4-trimethyl-1,3-pentanediol monoisobutyrate, or combinations thereof. In some embodiments, the coating formulations can include one or more coalescing aids such as propylene glycol n-butyl ether and/or dipropylene glycol n-butyl ether. The coalescing aids, if present, can be present in an amount of from greater than 0% to 30%, based on the dry weight of the copolymer. For example, the coalescing aid can be present in an amount of from 10% to 30%, from 15% to 30% or from 15% to 25%, based on the dry weight of the copolymer. In some embodiments, the coalescing aid can be included in coating formulations comprising a high Tg copolymer (that is a copolymer having a Tg greater than ambient temperature (e.g., 20° C.)). In these embodiments, the coalescing aid can be present in an effective amount to provide coating formulations having a Tg less than ambient temperature (e.g., 20° C.). In some embodiments, the compositions do not include a coalescing aid.

Defoamers serve to minimize frothing during mixing and/or application of the carpet binder. Suitable defoamers include organic defoamers such as mineral oils, silicone oils, and silica-based defoamers. Exemplary silicone oils include polysiloxanes, polydimethylsiloxanes, polyether modified polysiloxanes, or combinations thereof. Exemplary defoamers include BYK®-035, available from BYK USA Inc., the TEGO® series of defoamers, available from Evonik Industries, the DREWPLUS® series of defoamers, available from Ashland Inc., and FOAMASTER® NXZ, available from BASF Corporation.

Plasticizers can be added to the carpet binder compositions to reduce the glass transition temperature (T_{g}) of the compositions below that of the drying temperature to allow for good film formation. Suitable plasticizers include diethylene glycol dibenzoate, dipropylene glycol dibenzoate, tripropylene glycol dibenzoate, butyl benzyl phthalate, or a combination thereof. Exemplary plasticizers include phthalate based plasticizers. The plasticizer can be present in an amount of from 1% to 15%, based on the dry weight of the copolymer. For example, the plasticizer can be present in an amount of from 5% to 15% or from 7% to 15%, based on the dry weight of the copolymer. In some embodiments, the plasticizer can be present in an effective amount to provide coating formulations having a Tg less than ambient temperature (e.g., 20° C.). In some embodiments, the compositions do not include a plasticizer.

The compositions can further include a quick setting additive. The quick setting additive can decrease the setting time of the compositions. Exemplary quick setting additives suitable for use in the compositions described herein includes polyamines (i.e., polymers formed from either an amine-group containing monomer or an imine monomer as polymerized units such as aminoalkyl vinyl ether or sulfides; acrylamide or acrylic esters, such as dimethylaminoethyl(meth)acrylate; N-(meth)acryloxyalkyl-oxazolidines such as poly(oxazolidinylethyl methacrylate), N-(meth)acryloxyalkyltetrahydro-1,3-oxazines, and monomers that readily generate amines by hydrolysis). Suitable polyamines can include, for example, poly(oxazolidinylethyl methacrylate), poly(vinylamine), or polyalkyleneimine (e.g., polyethyleneimine). In some embodiments, the quick setting additive can include a derivatized polyamine such as an alkoxylated polyalkyleneimine (e.g., ethoxylated polyethyleneimine). Suitable derivatized polyamines are disclosed in U.S. Patent Application No. 2015/0259559 which is hereby incorporated herein by reference in its entirety. In some embodiments, the derivatized polyamines include an alkylated polyalkyleneimine (e.g., an alkylated polyethyleneimine or an alkylated polyvinylamine), a hydroxyalkylated polyalkyleneimine (e.g., a hydroxalkylated polyethyleneimine or a hydroxyalkylated polyvinylamine), an acylated polyalkyleneimine (e.g., an acylated polyethyleneimine or an acylated polyvinylamine), or a combination thereof. Derivatized polyamines are generally incorporated into the carpet binder compositions in amounts less than 10% by weight, based on the dry weight of the copolymer. The amount of derivatized polyamine present in the composition can be selected in view of the identity of the derivatized polyamine, the nature of the copolymer present in the composition, and the desired setting time of the composition. In some embodiments, the polyamine such as the derivatized polyamine can be present in the carpet binder composition at between 0.1% by weight and 5% by weight, based on the dry weight of the copolymer. In certain embodiments, the polyamine can be present in the carpet binder composition at between 0.5% by weight and 2.5% by weight, based on the dry weight of the copolymer.

Mineral filler (pigments) that can be included in the carpet binder compositions can be selected from TiO₂ (in both anastase and rutile forms), clay (aluminum silicate), CaCO₃ (in both ground and precipitated forms), aluminum trihydrate, fly ash, or aluminum oxide, silicon dioxide, magnesium oxide, talc (magnesium silicate), barytes (barium sulfate), zinc oxide, zinc sulfite, sodium oxide, potassium oxide and mixtures thereof. Examples of commercially available titanium dioxide pigments are KRONOS® 2101, KRONOS® 2310, available from Kronos WorldWide, Inc., TI-PURE® R-900, available from DuPont, or TIONA® AT1 commercially available from Millennium Inorganic Chemicals. Titanium dioxide is also available in concentrated dispersion form. An example of a titanium dioxide dispersion is KRONOS® 4311, also available from Kronos WorldWide, Inc. Suitable pigment blends of metal oxides are sold under the marks MINEX® (oxides of silicon, aluminum, sodium and potassium commercially available from Unimin Specialty Minerals), CELITE® (aluminum oxide and silicon dioxide commercially available from Celite Company), and ATOMITE® (commercially available from Imerys Performance Minerals). Exemplary fillers also include clays such as attapulgite clays and kaolin clays including those sold under the ATTAGEL® and ANSILEX® marks (commercially available from BASF Corporation). Additional fillers include nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), mica (hydrous aluminum potassium silicate), pyrophyllite (aluminum silicate hydroxide), perlite, baryte (barium sulfate), Wollastonite (calcium metasilicate), and combinations thereof. More preferably, the at least one filler includes TiO₂, CaCO₃, and/or a clay.

The mineral filler can comprise particles having a number average particle size of 50 microns or less (e.g., 45 microns or less, 40 microns or less, 35 microns or less, 30 microns or less, 25 microns or less, 20 microns or less, 18 microns or less, 15 microns or less, 10 microns or less, 8 microns or less, or 5 microns or less). In some embodiments, the mineral filler can have a number average particle size of 10 microns or greater, 12 microns or greater, 15 microns or greater, 20 microns or greater, 25 microns or greater, 30 microns or greater, 35 microns or greater, 40 microns or greater, or 45 microns or greater. In some embodiments, the mineral filler can have a number average particle size of from 10 microns to 50 microns, from 10 microns to 35 microns, or from 10 microns to 25 microns.

The mineral filler, if present, can be present in an amount of 10% or greater, based on the total weight of the carpet binder composition. For example, the mineral filler can be present in an amount of from 10% to 85%, from 15% to 75% or from 15% to 65%, based on the total weight of the carpet binder composition.

Examples of suitable thickeners include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener. Other suitable thickeners that can be used in the coating compositions can include acrylic copolymer dispersions sold under the STEROCOLL™ and LATEKOLL™ trademarks from BASF Corporation, Florham Park, N.J.; urethanes thickeners sold under the RHEOVIS® trademark (e.g., Rheovis PU 1214); hydroxyethyl cellulose; guar gum; carrageenan; xanthan; acetan; konjac; mannan; xyloglucan; and mixtures thereof. The thickeners can be added to the composition formulation as an aqueous dispersion or emulsion, or as a solid powder. In some embodiments, the thickeners can be added to the composition formulation to produce a viscosity of from 20 Pa-s to 50 Pa s (i.e., from 20,000 cP to 50,000 cP) at 20° C. The viscosity can be measured using a Brookfield type viscometer with a #3 spindle at 50 rpm at 20° C.

Examples of suitable pH modifying agents include bases such as sodium hydroxide, potassium hydroxide, amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof. In some embodiments, the compositions do not include an ammonia-based pH modifier. The pH of the dispersion can be greater than 7. For example, the pH can be 7.5 or greater, 8.0 or greater, 8.5 of greater, or 9.0 or greater.

Suitable biocides can be incorporated to inhibit the growth of bacteria and other microbes in the coating composition during storage. Exemplary biocides include 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OIT), 4,5-dichloro-2-n-octyl-3-isothiazolone, as well as acceptable salts and combinations thereof. Suitable biocides also include biocides that inhibit the growth of mold, mildew, and spores thereof in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc. The biocide can alternatively be applied as a film to the coating and a commercially available film-forming biocide is Zinc Omadine® commercially available from Arch Chemicals, Inc.

Exemplary co-solvents and humectants include ethylene glycol, propylene glycol, diethylene glycol, and combinations thereof. Exemplary dispersants can include sodium polyacrylates in aqueous solution such as those sold under the DARVAN trademark by R.T. Vanderbilt Co., Norwalk, Conn.

The copolymer can be present in the carpet binder compositions in an amount of 10% by weight or greater, based on the total weight of the carpet binder composition. For example, the copolymer can be present in an amount of 12% by weight or greater, 15% by weight or greater, 18% by weight or greater, 20% by weight or greater, 25% by weight or greater, or 30% by weight or greater, based on the total weight of the carpet binder composition. In some examples, the copolymer can be present in an amount of from 10% to 30%, from 15% to 30%, or from 15% to 25%, based on the total weight of the carpet binder composition.

The weight ratio between the mineral filler and the copolymer in the carpet binder compositions can be 1:1 or greater, such as from 1:1 to 20:1, based on the weight of solids in the copolymer and mineral filler.

Methods

The copolymers and carpet binder compositions disclosed herein can be prepared by any polymerization method known in the art. In some embodiments, the copolymers disclosed herein are prepared by a dispersion, a mini-emulsion, or an emulsion polymerization. The copolymers disclosed herein can be prepared, for instance, by polymerizing the vinyl aromatic monomer, the diene monomer, and optionally an additional monomer selected from a copolymerizable surfactant, a methacrylate monomer, a carboxylic acid monomer, further monomers, or a combination thereof. In some embodiments, the polymerization medium is an aqueous medium. Thus, the emulsion polymerization medium can include an aqueous emulsion comprising water, the vinyl aromatic monomer, the diene monomer, and optionally an additional monomer selected from a copolymerizable surfactant, a methacrylate monomer, a carboxylic acid monomer, further monomers, or a combination thereof. Solvents other than water can be used in the emulsion.

The emulsion polymerization can be carried out either as a batch, semi-batch, or continuous process. In some embodiments, a portion of the monomers can be heated to the polymerization temperature and partially polymerized, and the remainder of the polymerization batch can be subsequently fed to the polymerization zone continuously, in steps or with superposition of a concentration gradient. The process can use a single reactor or a series of reactors as would be readily understood by those skilled in the art. For example, a review of heterophase polymerization techniques is provided in M. Antonelli and K. Tauer, Macromol. Chem. Phys. 2003, vol. 204, p 207-19.

A copolymer dispersion can be prepared by first charging a reactor with water, a vinyl aromatic monomer, a diene monomer, and optionally an additional monomer selected from a copolymerizable surfactant, a methacrylate monomer, a carboxylic acid monomer, further monomers, or a combination thereof. A seed latex, though optional, can be included in the reactor to help initiate polymerization and helps produce a polymer having a consistent particle size. Any seed latex appropriate for the specific monomer reaction can be used such as a polystyrene seed. The initial charge can also include a chelating or complexing agent such as ethylenediamine tetraacetic acid (EDTA). Other components such as chain transfer agents, surfactants, and buffers can be added to the reactor to provide the desired pH for the emulsion polymerization reaction. For example, bases or basic salts such as KOH or tetrasodium pyrophosphate can be used to increase the pH whereas acids or acidic salts can be used to decrease the pH. The initial charge can then be heated to a temperature at or near the reaction temperature. The reaction temperature can be, for example, between 50° C. and 100° C. (e.g., between 55° C. and 95° C., between 58° C. and 90° C., between 61° C. and 85° C., between 65° C. and 80° C., or between 68° C. and 75° C.).

After the initial charge, the monomers that are to be used in the polymerization can be continuously fed to the reactor in one or more monomer feed streams. The monomers can be supplied as a pre-emulsion in an aqueous medium. An initiator feed stream can also be continuously added to the reactor at the time the monomer feed stream is added although it may also be desirable to include at least a portion of the initiator solution to the reactor before adding a monomer pre-emulsion if one is used in the process. The monomer and initiator feed streams are typically continuously added to the reactor over a predetermined period of time (e.g., 1.5-5 hours) to cause polymerization of the monomers and to thereby produce the polymer dispersion. An aryl phosphate surfactant and/or any other surfactants can be added at this time as part of either the monomer stream or the initiator feed stream although they can be provided in a separate feed stream. Furthermore, one or more buffers can be included in either the monomer or initiator feed streams or provided in a separate feed stream to modify or maintain the pH of the reactor.

As mentioned above, the monomer feed stream can include one or more monomers (e.g., a vinyl aromatic monomer, a diene monomer, and optionally an additional monomer selected from a copolymerizable surfactant, a methacrylate monomer, a carboxylic acid monomer, further monomers, or a combination thereof). The monomers can be fed in one or more feed streams with each stream including one or more of the monomers being used in the polymerization process. For example, the vinyl aromatic monomer, the diene monomer, and the optional monomers, can be provided in separate monomer feed streams or can be added as a pre-emulsion. It can also be advantageous to delay the feed of certain monomers to provide certain polymer properties or to provide a layered or multiphase structure (e.g., a core/shell structure). In some embodiments, the copolymers are polymerized in multiple stages to produce particles having multiple phases. In some embodiments, the copolymers are polymerized in a single stage to produce a single phase particle.

The initiator feed stream can include at least one initiator or initiator system that is used to cause the polymerization of the monomers in the monomer feed stream. The initiator stream can also include water and other desired components appropriate for the monomer reaction to be initiated. The initiator can be any initiator known in the art for use in emulsion polymerization such as azo initiators; ammonium, potassium or sodium persulfate; or a redox system that typically includes an oxidant and a reducing agent. Commonly used redox initiation systems are described, e.g., by A. S. Sarac in Progress in Polymer Science 24, 1149-1204 (1999). Exemplary initiators include azo initiators and aqueous solutions of sodium persulfate. The initiator stream can optionally include one or more buffers or pH regulators. In some embodiments, ammonia is not used during polymerization of the copolymers. Accordingly, the copolymer compositions can be free or substantially free of ammonia.

Once polymerization is completed, the copolymer dispersion can be chemically stripped thereby decreasing its residual monomer content. This stripping process can include a chemical stripping step and/or a physical stripping step. In some embodiments, the polymer dispersion is chemically stripped by continuously adding an oxidant such as a peroxide (e.g., t-butylhydroperoxide) and a reducing agent (e.g., sodium acetone bisulfite), or another redox pair to the reactor at an elevated temperature and for a predetermined period of time (e.g., 0.5 hours). Suitable redox pairs are described by A. S. Sarac in Progress in Polymer Science 24, 1149-1204 (1999). An optional defoamer can also be added if needed before or during the stripping step. In a physical stripping step, a water or steam flush can be used to further eliminate the non-polymerized monomers in the dispersion. Once the stripping step is completed, the pH of the polymer dispersion can be adjusted and a biocide or other additives can be added. Defoamers, surfactants, dispersing agents, mineral fillers, coalescing aids, or a plasticizer can be added after the stripping step or at a later time if desired.

Once the polymerization reaction is complete, and the stripping step is completed, the temperature of the reactor can be reduced.

As disclosed herein, the copolymers can be used in coating compositions. The coating compositions can be used for several applications, including carpet binders. The carpet binder composition can be applied to a surface by any suitable coating technique, including spraying, rolling, brushing, or spreading. For example, the carpet binder composition can be applied to a face yarn, a primary backing, or a secondary backing for use in adhering a primary backing to a face yarn or a secondary backing to a surface of the primary backing. The face yarn can be selected from the group consisting of polyolefins, polyamides, polyesters, polyethylene terephthalate (PET), polytrimethylene terephthalate (PTT), natural fibers, and mixtures thereof. The primary backing and/or the secondary backing can be selected from the group consisting of polyolefins, polyamides, natural fiber, and mixtures thereof, preferably comprising polypropylene fibers.

The carpet binder composition can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and/or by circulating air over the coating. The coating can have a thickness of 1,500 g/m² or less, 1,300 g/m² or less, 1,200 g/m² or less, 1,000 g/m² or less, from 800 g/m² to 1,500 g/m² or from 800 g/m² to 1,200 g/m².

In some embodiments, the carpet binder composition has a froth (foam) viscosity of 28,000 cp to 35,000 cp, preferably from 30,000 cp to 35,000 cp, as determined using a Brookfield viscometer at 21° C., spindle #6 at 20 rpm.

In some embodiments, the carpet binder composition can have a wet delamination strength for a straight stitch nylon loop carpet, as determined using ASTM D3936, of at least 7 psi, at least 8 psi, at least 10 psi, at least 12 psi, or at least 14 psi, for a 7.62 cm wide strip.

In some embodiments, the carpet binder composition can have a dry delamination strength for a straight stitch nylon loop carpet, as determined using ASTM D3936, of at least 12.5 psi, at least 14 psi, at least 15 psi, at least 16 psi, or at least 17 psi, for a 7.62 cm wide strip.

By way of non-limiting illustration, examples of certain embodiments of the present disclosure are given below.

### EXAMPLES

### Example 1: High Delamination Strength Carpet Binder

Introduction: Most conventional carpets comprise a primary backing with yarn tufts that extend upwards from the backing and form a pile surface. For tufted carpets the yarn is inserted into the primary backing by tufting needles and a primary coating (pre-coat) is applied to secure the yarn tufts. The pre-coat is required to secure the carpet tufts to the primary backing. For non-tufted carpets the fibers are embedded and are held in place by the pre-coat. Carpet construction also includes a secondary backing laminated or bonded to the primary backing by an adhesive formulation that can include the same binder as the one used for the pre-coat. The secondary backing provides dimensional stability, absorbs noise, and provides extra padding to the carpet. The secondary backing is laminated to the primary backing by a binder composition applied to the tuft-locked coated primary backing or applied directly to the secondary backing. Similar techniques are practiced in the construction of either broadloom carpet or carpet tiles.

The properties of the binder used for the precoat and the adhesive formulations are important for the construction of the carpet. The binder provides for adhesion of the precoat to the pile fibers and to the bonding of the secondary backing to the primary backing. In addition, the backing coating is generally soft and flexible even at high filler loading and/or low temperature to make the carpet easily rolled and unrolled during installation.

A consideration for carpet quality is durability which is reflected in the delamination strength of the carpet. Delamination strength refers to the resistance to separate the primary backing from the secondary backing under dry or wet conditions, such as during carpet cleaning. Of course, the ability of the carpet to resist separation of individual pile filaments from the primary backing is important to a high-quality carpet. During application of the carpet coating to the primary backing, it is desirable to froth, that is to create air bubbles in the precoat, by incorporating a gas, usually air, via mixing of the components of the carpet formulation. Frothing of the precoat aids in coat weight control and as such can impact the carpet manufacturing cost. Desirable frothing carpet formulations include those in which the frothed compound density is achieved quickly and reproducibly. Frothing agents can be used in the carpet formulation to aid in the process of bubble creation. Frothing agents are surface active materials that lower the surface tension of the air/liquid surfaces created by the incorporation of air into the carpet coating. However, for good adhesion of the tufts to the primary backing is the ability to control the stability of the air/liquid surfaces such that they collapse just in time before the carpet formulation dries completely as the carpet passes through the plant ovens during manufacture. If the froth is stable and does not collapse before or very early in the drying process, the amount of coating at the tuft/primary backing interfaces is reduced and as a result adhesion (tuftlock) of the tufts to the primary backing is reduced.

This example is based on the discovery that latexes made using polymerizable (reactive) surfactants during the emulsion polymerization process when formulated into carpet coatings provide superior dry and wet delamination strength. Alternately or in addition, if hydrophilic monomers such as methyl methacrylate are used to replace part of the styrene in a styrene-butadiene composition, carpet formulations using such a latex polymer possess high dry and, especially, wet delamination strength, particularly high wet delamination strength. Further, latexes made with bulky phosphate surfactant or other phosphate surfactants, whether reactive or not, during the emulsion polymerization process, when formulated into carpet coatings provide superior dry and wet delamination strength. The carpet formulations described herein have desirable froth viscosities. In particular, froth viscosities of 28,000 cp or higher are desirable as it allows for favorable lamination of the secondary backing to the primary backing.

Because of the superior performance of the carpet formulations described herein, the carpet formulations can be made at higher filler loading resulting in significant cost savings.

Method: Copolymer dispersions derived from styrene and butadiene as described in Table 1 were prepared. Conventional residential carpet binders were formulated from the copolymers. The froth viscosities and dry and wet delamination strengths were determined on the carpet binder samples. Table 1 summarizes the froth viscosities (determined using a Brookfield viscometer at 21° C., spindle #6 at 20 rpm), and dry and wet delamination strengths (determined using ASTM D3936).

Commercially available latexes available were used as control in the examples.

TABLE 1
High strength binder compositions.

| | | | | Acid | | | Froth | Dry | Wet |
|---|---|---|---|---|---|---|---|---|---|
| Sample | Tg, | Styrene, | Butadiene, | monomers, | MMA, | Surfactant, | viscosity, | Delamination | Delamination |
| ID | ° C. | pphm | pphm | pphm | pphm | pphm | cp | strength, psi | strength, psi |
| 1 | 17 | 53.9 | 33.3 | 3.0 | 9.9 | Non- | 35,000 | 14.9 | 10.6 |
| | | | | | | reactive, | | | |
| | | | | | | 0.37 | | | |
| 2 | 18 | 49.0 | 33.3 | 2.7 | 15 | Non- | 30,000 | 14.7 | 10.5 |
| | | | | | | reactive, | | | |
| | | | | | | 0.37 | | | |
| 3 | 18 | 63.8 | 33.2 | 2.7 | 0 | Reactive, | 33,000 | 16.8 | 8.92 |
| | | | | | | 0.37 | | | |
| 4 | 20 | 64 | 33.3 | 2.7 | 0 | Phosphate, | 32,000 | 14.7 | 8.85 |
| | | | | | | 0.37 | | | |
| CE1 | ~13° C. | — | — | — | — | — | 33,000 | 10.7 | 5.8 |
| CE2 | ~13° C. | — | — | — | — | — | 36,500 | 11.2 | 2.8 |

* CE 1 and CE2 are commercially available carboxylated styrene/butadiene dispersions.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising”, and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1.-69. (canceled)

70. A carpet binder composition, comprising:
a copolymer produced by emulsion polymerization and derived from monomers comprising a vinyl aromatic monomer, a 1,3-diene monomer, and an additional monomer selected from a copolymerizable surfactant, a (meth)acrylate monomer, a carboxylic acid monomer, or a combination thereof, and
a mineral filler;
wherein the composition has a one minute wet delamination strength for a 7.62 cm wide straight stitch nylon loop carpet, as determined using ASTM D3936, of 7 psi or greater.

71. The composition according to claim 70, wherein the carpet binder composition further comprises an additional surfactant.

72. The composition according to claim 71, wherein the additional surfactant is selected from an aryl phosphate surfactant.

73. The composition according to claim 70, wherein the additional monomer comprises a (meth)acrylate monomer.

74. The composition according to claim 70, wherein the wet delamination strength for a 7.62 cm wide straight stitch nylon loop carpet, as determined using ASTM D3936, is at least 8 psi.

75. The composition according to claim 70, wherein the composition has a dry delamination strength for a 7.62 cm wide straight stitch nylon loop carpet, as determined using ASTM D3936, of 12.5 psi or greater.

76. The composition according to claim 70, wherein the composition has a froth (foam) viscosity of 28,000 cp to 35,000 cp, as determined using a Brookfield viscometer at 21° C., spindle #6 at 20 rpm.

77. The composition according to claim 70, wherein the copolymer is derived from the copolymerizable surfactant selected from the group consisting of an acrylic acid-modified polyoxyethylene alkyl ether, an acrylic acid-modified polyoxyethylene alkyl phenyl ether, an allylic acid-modified polyoxyethylene alkyl ether, an allylic acid-modified polyoxyethylene alkyl phenyl ether, an allylic acid-modified polyoxyethylene polystyrylphenyl ether, an acrylic acid-modified polyoxyethylene polystyrylphenyl ether, polyoxyethylene-polyoxypropylene glycol monoacrylate, and mixtures thereof.

78. The composition according to claim 70, wherein the copolymerizable surfactant is of formula I, or a salt thereof: 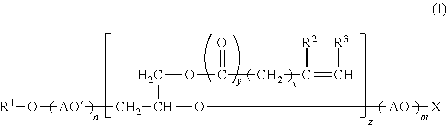
wherein R¹ represents a branched aliphatic hydrocarbon group, a secondary aliphatic hydrocarbon group or a branched aliphatic acyl group, AO and AO′ each independently represents an oxyalkylene group having 2 to 4 carbon atoms, R² and R³ each independently represents a hydrogen atom or a methyl group, X represents a hydrogen atom or an ionic hydrophilic group, x is an integer from 0 to 12, y is 0 or 1, z is an integer from 1 to 10, m is an integer from 0 to 1,000, and n is an integer from 0 to 1,000.

79. The composition according to claim 70, wherein the copolymerizable surfactant is of formula Ia: 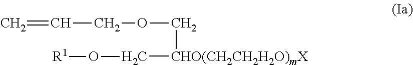
wherein R¹ is C₉-C₁₅ alkyl or C₇-C₁₁ alkyl-phenyl, X is H, SO₃NH₄ and/or SO₃Na, and m is 3 to 50.

80. The composition according to claim 70, wherein the copolymer is derived from greater than 0% to 5% by weight, of the copolymerizable surfactant.

81. The composition according to claim 72, wherein the aryl phosphate surfactant is an alkoxylated polyarylphenol phosphate ester of the formula (VII):
CₓH_{y}—O-(AO)ₙPO₄²⁻ (VII)
wherein AO represents an oxyalkylene group having 2 to 4 carbon atoms;
CₓH_{y} represents one or more substituted or unsubstituted aryl groups wherein x is an integer 20 or greater, and y is an integer 14 or greater; and
n is an integer 1 or greater.

82. The composition according to claim 72, wherein the aryl phosphate surfactant is an alkoxylated polyarylphenol phosphate ester of the formula (VIIIa): 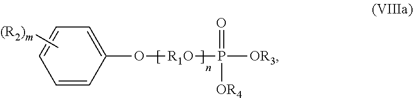
wherein R₁ independently is a straight chain or branched C₂-C₄ alkylene, R₂ is aryl or alkylaryl, wherein R₂ is unsubstituted or substituted by one to three groups selected from the group consisting of C₁-C₄ alkyl or C₁-C₄ alkoxy, and R₃ and R₄ are independently selected from the group consisting of hydrogen, sodium, potassium, ammonium, and 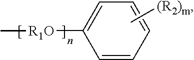
m is 2 or 3, and n is a number from 1 to 150 inclusive.

83. The composition according to claim 72, wherein the aryl phosphate surfactant has the formula (IX): 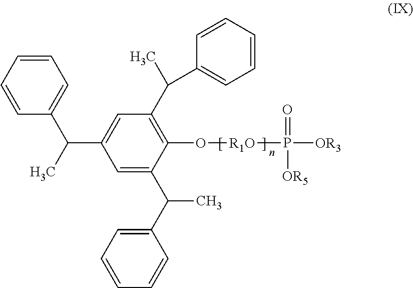
wherein R₁ and n are defined as above, preferably R₁ is ethylene, and R₃ and R₅ are independently selected from the group consisting of hydrogen, sodium, potassium, and ammonium.

84. The composition according to claim 70, wherein the (meth)acrylate monomer is selected from methyl (meth)acrylate, ethyl (meth)acrylate, t-butyl (meth)acrylate, cyclohexyl (meth)acrylate, or combinations thereof.

85. The composition of claim 70, wherein the copolymer is derived from a carboxylic acid monomer present in an amount from 0.5% to 4% by weight, of the copolymer.

86. The composition according to claim 70, wherein the copolymer includes:
40% to 80% by weight styrene;
15% to 55% by weight of butadiene;
an additional monomer selected from a copolymerizable surfactant, methyl methacrylate, acrylic acid, or a combination thereof, and
0% to 4% by weight of one or more further monomers selected from an additional (meth)acrylate monomer, a (meth)acrylonitrile monomer, a (meth)acrylamide monomer, an organosilane, a crosslinking monomer, glycidyl (meth)acylate, or a combination thereof.

87. The composition according to claim 70, wherein the copolymer includes:
40% to 80% by weight styrene;
20% to 55% by weight of butadiene;
1.5% to 5% by weight of a carboxylic acid monomer selected from acrylic acid, itaconic acid, or a combination thereof,
5% to 30% by weight of methyl methacrylate; and
0% to 4% by weight of one or more further monomers selected from an additional (meth)acrylate monomer, a (meth)acrylonitrile monomer, a (meth)acrylamide monomer, an organosilane, a crosslinking monomer, glycidyl (meth)acylate, or a combination thereof.

88. The composition according to claim 70, wherein the copolymer includes:
40% to 80% by weight styrene;
20% to 55% by weight of butadiene;
1.5% to 5% by weight of a carboxylic acid monomer selected from acrylic acid, itaconic acid, or a combination thereof,
0.1% to 2% by weight of a copolymerizable surfactant; and
0% to 4% by weight of one or more further monomers selected from an additional (meth)acrylate monomer, a (meth)acrylonitrile monomer, a (meth)acrylamide monomer, an organosilane, a crosslinking monomer, glycidyl (meth)acylate, or a combination thereof.

89. The composition according to claim 70, wherein the mineral filler and the copolymer are in a weight ratio of from 1:1 to 20:1, based on the weight of solids in the copolymer.

90. The composition according to claim 70, wherein the mineral filler includes calcium carbonate, titanium dioxide, kaolin, bentonite, mica, talc, attapulgite, zeolite, aluminum trihydrate, fly ash, or mixtures thereof.

91. The composition according to claim 70, wherein the mineral filler has a number average particle size of 10 microns or greater.

92. The composition according to claim 70, further comprising a thickener, a surfactant, a dispersant, or a combination thereof.

93. A method of making a carpet binder composition, comprising:
mixing a copolymer produced by emulsion polymerization and derived from monomers comprising a vinyl aromatic monomer, a 1,3-diene monomer, and an additional monomer selected from a copolymerizable surfactant, a (meth)acrylate monomer, a carboxylic acid monomer, or a combination thereof, and a mineral filler to form a mixture, wherein the mixture develops a one minute wet delamination strength for a 7.62 cm wide straight stitch nylon loop carpet, as determined using ASTM D3936, of 7 psi or greater; and
allowing the mixture to cure.

94. A method of adhering a primary backing to a face yarn, the method comprising binding the primary backing to the face yarn and binding a secondary backing to a surface of the primary backing using a carpet binder composition according to claim 70, wherein the face yarn is selected from the group consisting of polyolefins, polyamides, polyesters, polyethylene terephthalate (PET), polytrimethylene terephthalate (PTT), natural fibers, and mixtures thereof, and the primary backing and the secondary backing are selected from the group consisting of polyolefins, polyamides, natural fiber, and mixtures thereof.

95. A copolymer produced by emulsion polymerization and consisting essentially of a vinyl aromatic monomer, a 1,3-diene monomer, a copolymerizable surfactant, and optionally a carboxylic acid monomer.

96. The copolymer according to claim 95 wherein the copolymer is derived from 5%-80% by weight, of the vinyl aromatic monomer.

97. The copolymer according to claim 95, wherein the vinyl aromatic monomer comprises styrene.

98. The copolymer according to claim 95, wherein the copolymer is derived from 5%-80% by weight, of the 1,3-diene monomer.

99. The copolymer according to claim 95, wherein the 1,3-diene monomer comprises butadiene.

100. The copolymer according to claim 95, wherein the copolymerizable surfactant is of formula I, or a salt thereof 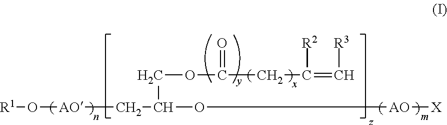
wherein R¹ represents a branched aliphatic hydrocarbon group, a secondary aliphatic hydrocarbon group or a branched aliphatic acyl group, AO and AO′ each independently represents an oxyalkylene group having 2 to 4 carbon atoms, R² and R³ each independently represents a hydrogen atom or a methyl group, X represents a hydrogen atom or an ionic hydrophilic group, x is an integer from 0 to 12, y is 0 or 1, z is an integer from 1 to 10, m is an integer from 0 to 1,000, and n is an integer from 0 to 1,000.

101. The copolymer according to claim 95, wherein the copolymerizable surfactant is of formula Ia: 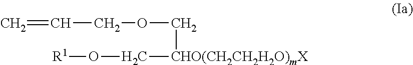
wherein R¹ is C₉-C₁₅ alkyl or C₇-C₁₁ alkyl-phenyl, X is H, SO₃NH₄ and/or SO₃Na, and m is 3 to 50.
